(19) United States
(12) Patent Application Publication
(10) Pub. No.: US 2003/0232230 A1
(43) Pub. Date: Dec. 18, 2003

(54) Solid oxide fuel cell with enhanced mechanical and electrical properties

(76) Inventors: John David Carter, Bolingbrook, IL (US); Joong-Myeon Bae, Naperville, IL (US); Terry Alan Cruse, Lisle, IL (US); James Michael Ralph, Chicago, IL (US); Romesh Kumar, Naperville, IL (US); Michael Krumpelt, Naperville, IL (US)

Correspondence Address: Joan Pennington, Unit # 1804, 535 North Michigan Avenue, Chicago, IL, 60611, US

(21) Appl. No.: 10/167,917

(22) Filed: Jun. 12, 2002

(51) Int. Cl. H01M 8/12; H01M 8/24

(52) U.S. Cl. 429/32; 429/38; 264/618

(57) ABSTRACT

A solid oxide fuel cell (SOFC) repeat unit includes an oxide electrolyte, an anode, a metallic fuel flow field, a metallic interconnect, and a metallic air flow field. The multilayer laminate is made by casting tapes of the different functional layers, laminating the tapes together and sintering the laminate in a reducing atmosphere. Solid oxide fuel cell stacks are made by applying a cathode layer, bonding the unit into a gas manifold plate, and then stacking the cells together. This process leads to superior mechanical properties in the SOFC due to the toughness of the supporting metallic layers. It also reduces contact resistances in stacking the cells since there is only one physical contact plane for each repeat unit.

### RELATED APPLICATION

A related U.S. patent application Ser. No. ______, by Michael Krumpelt, Terry A. Cruse, John David Carter, Jules L. Routbort, and Romesh Kumar and assigned to the present assignee is being filed on the same day as the present patent application entitled “COMPOSITIONALLY GRADED METALLIC PLATES FOR PLANAR SOLID OXIDE FUEL CELLS”.

### CONTRACTUAL ORIGIN OF THE INVENTION

The United States Government has rights in this invention pursuant to Contract No. W-31-109-ENG-38 between the United States Government and Argonne National Laboratory.

### FIELD OF THE INVENTION

The present invention relates to solid oxide fuel cells (SOFCs), and more particularly, relates to an improved planar solid oxide fuel cell having improved mechanical strength and electrical properties and a method of making this improved solid oxide fuel cell.

### DESCRIPTION OF THE RELATED ART

Fuel cells are conversion devices that generate electricity through the electrochemical oxidation of a fuel. Solid Oxide Fuel Cells (SOFCs) are based on an oxygen-ion conducting ceramic electrolyte, such as zirconium oxide, cerium oxide, or lanthanum gallate. Oxygen is supplied continuously to the cathode where it is dissociated into oxygen ions. The ions diffuse through the electrolyte and react with a fuel, which is continuously flowing into the anode compartment. Diffusing oxygen ions generate an electric current. The SOFC output voltage is increased by stacking individual cells in electrical series. Bipolar plates connect adjacent cells electrically, separating the oxidant and fuel gases from each other.

Solid Oxide Fuel Cells show promise as electrical power sources for many applications, ranging from large stationary power plants to auxiliary power units for vehicles. This fuel cell type is proven to have a high energy density, demonstrating over 1 W/cm² in small single cells. Moreover, SOFCs are not limited to hydrogen as a fuel. Carbon monoxide, methane, alcohols, light hydrocarbons, and distillate fuels have been shown to reform directly on the SOFC anode, thereby greatly reducing the complexity of the prereformer.

The most developed SOFC power generator has a tubular cell configuration. As described in U.S. Pat. No. 4,490,444, the tubular cells are bundled into series/parallel units to increase voltage output and reduce ohmic losses. The cells are presently fabricated by forming a porous cathode tube, and depositing the electrolyte, and interconnect on its surface. This configuration is inherently expensive since the electrolyte and interconnect are applied using multiple high temperature electrochemical vapor deposition steps. The tubular configuration also operates at high temperatures of 1000° C. and has a low power density of about 100 mW/cm² due to in-plane conduction of the current around the perimeter of the tubes.

A planar solid oxide fuel cell consists of an anode and a cathode separated by a solid electrolyte. A SOFC stack consists of a series of cells, stacked one above the other, in which the anode of one cell and the cathode of the adjacent cell are separated by an interconnect or bipolar plate. The bipolar plate serves two primary functions. The bipolar plate prevents the mixing of the fuel and oxidant gases provided to the anode and cathode of the cells. The bipolar plate also serves to connect the adjacent cells in electrical series. The bipolar plate may also provide the field flow channels to direct the fuel and oxidant gases to the appropriate electrode.

Planar SOFCs have higher power densities since the current flows are perpendicular to the plane of the cell, resulting in short path lengths. They can also be fabricated using low-cost processes. For example, monolithic SOFCs are described in U.S. Pat. Nos. 4,476,196; 4,476,197; and 4,476,198. This concept involves bonding thin tape cast laminates of cathode/electrolyte/anode and cathode/interconnect/anode together in a corrugated stack. The stack is sintered together in single step. The method of fabrication was further modified by Minh et al. in U.S. Pat. Nos. 4,913,982; 5,162,167; and 5,256,499. By using tape-calendaring methods the electrolyte thickness could be reduced to the point were the operating temperature of the SOFC could be lowered to below 800° C. without loss of performance.

As a result of reducing the operating temperature, metal interconnects can replace the more expensive ceramic interconnects. Using metal interconnects, high power densities of 650 mW/cm² were achieved in stacks built as described in U.S. Pat. No. 6,296,962 The various types of planar SOFCs have a major disadvantage. By nature, ceramic stacks are subject to brittle failure. Impact or vibration can break the cells, which makes SOFCs unattractive for mobile applications. Planar SOFCs can be categorized into electrolyte, anode or cathode supported design. Historically, cells were made by starting with a relatively thick (about 1 mm) layer of zirconia, which is the electrolyte. Anodes and cathodes were then deposited on either side. In this type of cell, the zirconia is the structural element determining the mechanical properties of the fuel cell.

A significant disadvantage of this type of cell is the relatively high electrical resistance resulting from the thick electrolyte layer. To overcome this problem, and to obtain improved performance, researchers developed cells where the structural element is either the anode or the cathode. In these cells the anode or the cathode is about 1 mm thick but the electrolyte is thin, for example, 5-20 micrometers. In all of these cells the bipolar plate is loosely bonded to the anode/electrolyte/cathode assembly, which is a free standing structure and is brittle.

To function properly, the bipolar plate must be dense enough to prevent mixing of the fuel and oxidant gases, electrically conductive, chemically and mechanically stable under the fuel cell's operating environment (oxidizing and reducing conditions, temperatures up to 1000° C. for the high temperatures SOFCs and up to 800° C. for the lower temperature SOFCs), and its coefficient of thermal expansion should be close to that of the zirconia-based SOFCs. An advantage of this type of cell is the relatively high electrical resistance resulting from the thick electrolyte layer. To overcome this problem, and to obtain improved performance, researchers have developed cells where the structural element is either the anode or the cathode. In these cells, the anode or the cathode is about 1 mm thick but the electrolyte is thin (5-20 micrometers). In all of these cells, the bipolar plate is loosely bonded to the anode/electrolyte/cathode assembly, which is free standing and brittle.

A principal object of the present invention is to provide an improved solid oxide fuel cell (SOFC) repeat unit having enhanced mechanical strength and electrical properties and a method of making the improved SOFC repeat unit.

Other important objects of the present invention are to provide such improved SOFC repeat unit and method of making the improved SOFC repeat unit substantially without negative effect; and that overcome some disadvantages of prior art arrangements.

### SUMMARY OF THE INVENTION

In brief, a repeat unit having enhanced mechanical and electrical properties and method of making the repeat unit are provided for forming an improved solid oxide fuel cell (SOFC). The repeat unit includes a multilayer laminate including a oxide electrolyte, an anode, a metallic fuel flow field, a metallic interconnect, and a metallic air flow field.

In accordance with features of the invention, mechanical strength is derived from the supporting metallic layers, thereby improving the impact and fracture resistance of the electrolyte. The repeat units are fabricated in a high temperature, reducing atmosphere process that bonds the electrolyte and the metallic layers together. After applying the cathode and appropriate seals, this repeat unit is used to build a SOFC stack. An advantage of the present invention is the elimination of contact resistance between stacking elements, because the electrolyte, anode, the two metallic flow fields, and the metallic interconnect are bonded together as a unit.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 illustrates a solid oxide fuel cell repeat unit in accordance with the preferred embodiment;

FIG. 2 illustrates the solid oxide fuel cell repeat unit of FIG. 1 together with an additional sealing gasket and a gas manifold plate forming a solid oxide fuel cell stack in accordance with the preferred embodiment;

FIG. 3 is a flow chart illustrating exemplary steps for producing the solid oxide fuel cell repeat unit of FIG. 1 in accordance with the preferred embodiment; and

FIG. 4 shows an exemplary repeat unit fabricated in accordance with the process of the present invention.

### DETAILED DESCRIPTION OF THE PREFERRED EMBODIMENTS

In accordance with features of the invention, a solid oxide fuel cell repeat unit is provided having improved mechanical and electrical properties. The repeat unit includes a thin film ceramic electrolyte, metal-ceramic anode, metal fuel flow field, multilayer metal interconnect, and metal air flow field. Mechanical strength is derived from the supporting metal layers, thereby improving the impact and fracture resistance of the electrolyte. Repeat units are fabricated in a high temperature, reducing atmosphere process that bonds the electrolyte and the metallic layers together. Solid oxide fuel cell repeat units are formed by slurry casting processes followed by multilayer lamination, binder removal, and sintering in a reducing or otherwise controlled oxygen-free atmosphere. Traditional ceramic sintering takes place in air to achieve a dense oxide.

In accordance with features of the invention, sintering is performed under a controlled reducing atmosphere to prevent the metal components from oxidizing, while maintaining the oxidized state of the ceramic oxide. An added benefit gained from this invention is the elimination of contact resistance between stacking elements including the cell, flow fields and interconnect. Since the repeat unit is bonded together during sintering, the interconnect maintains an electrical conduction path to the cell even if insulating corrosion layers form on the exposed surfaces of the interconnect or flow fields. In building a stack, electrical contact is made between the air flow field and the cathode. At this plane, the connection can be made by coating the foam ends with a metal or alloy that will maintain ohmic contact.

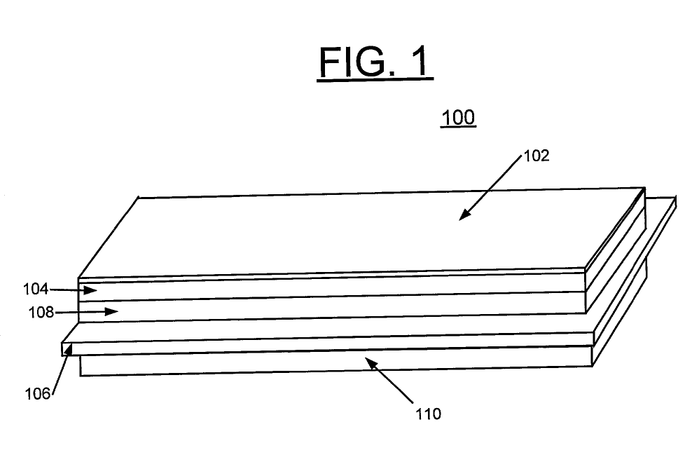

Having reference now to the drawings, in FIG. 1 there is shown a solid oxide fuel cell repeat unit in accordance with the preferred embodiment generally designated by the reference character 100. Solid oxide fuel cell repeat unit includes an electrolyte 102, an anode 104, and an interconnect 106 separating a fuel flow field 108 and an air flow field 110.

The electrolyte 102 of the preferred embodiment is a thin film of an oxygen ion-conducting material, having a thickness ranging between 1 to 50 micrometers, typically 5-30 micrometers thick. The electrolyte 102 can include a single layer or multiple layers of an ion-conducting material, for example yttria-stabilized zirconium oxide, doped cerium oxide or doped lanthanum gallium oxide. The electrolyte 102 is preferably formed of yttria-stabilized zirconia (YSZ) or could be formed of other oxides, such as doped cerium oxide or doped lanthanum gallium oxide. The electrolyte 102 may also consist of a combination of multiple layers; for example, a thin 1-micrometer layer of YSZ overlaid with a 10-micrometer layer of doped ceria.

The anode 104 is a metal-ceramic anode consisting of a single or multiple layers made up of a mixture of pore formers, nickel, nickel alloys, or other suitable electrocatalytic metals and an ion-conducting oxide, for example yttria stabilized zirconium oxide, doped cerium oxide, or doped lanthanum gallium oxide. Anode 104 is preferably formed of a porous cermet consisting of preferably nickel mixed with YSZ. Anode 104 may contain other elements such as alloying elements of nickel, other metals, or other oxides such as doped-ceria to improve the stability and performance of the electrode; such additions may be used especially to improve the sulfur tolerance of the anode 104. The anode electrode layer needs to be porous to allow the flow of reactants and products to and from the electrolyte interface. Consequently, graphite and organic materials are added to the slurry that decompose at various stages and leave behind porosity in the anode 104.

The interconnect 106 is a dense metal layer that separates the anode and cathode compartments of the fuel cell, provides electrical connection between adjacent cells and provides strength to the repeat unit 100. Interconnect 106 is bonded between the fuel and air flow fields 108, 110 during the sintering process, thereby eliminating a contact plane that exists in prior art where preformed interconnects are assembled with preformed cells.

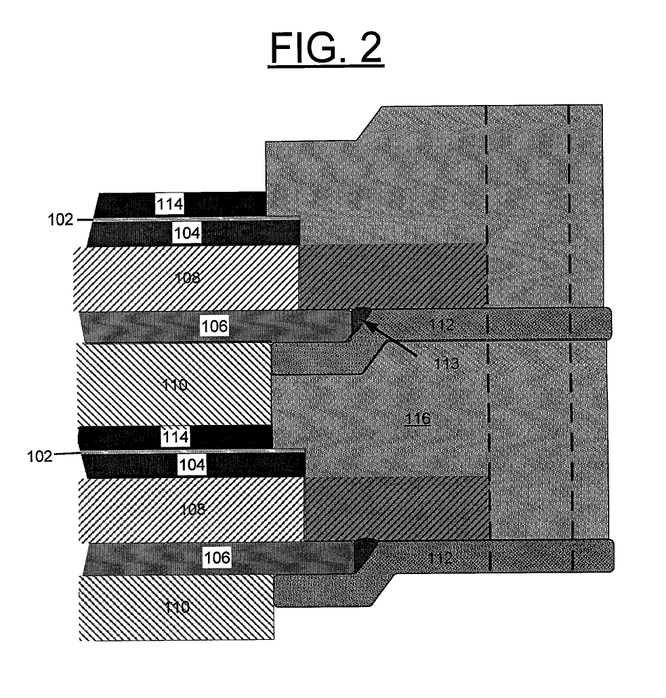

Referring also to FIG. 2, the interconnect layer 106 is made to extend out beyond the other layers 102, 104, 108, 110 to provide a surface to bond the repeat unit 100 to a mounting plate 112 defined by the gas manifold 112 shown in FIG. 2. A cathode 114 is attached to the electrolyte 102 of the repeat unit 100. Then the repeat unit 100 is brazed or attached to the gas manifold plate 112 indicated by brazing generally designated 113. A compressible mica-based high temperature gasket 116 provides further sealing.

The interconnect 106 may consist of a single metal or preferably a graded composite of metals that are arranged so that one surface of the interconnect 106 consists of a metal suited to the cathode compartment and the other surface consists of a metal suited to the anode compartment of the fuel cell. The above-identified related U.S. patent application entitled “COMPOSITIONALLY GRADED METALLIC PLATES FOR PLANAR SOLID OXIDE FUEL CELLS” discloses a method for preparing compositionally graded metallic plates and compositionally graded metallic plates suitable for use as interconnects for solid oxide fuel cells. The subject matter of the above-identified related U.S. patent application is incorporated herein by reference.

The fuel flow field 108 and the air flow field 110 are formed by coating a reticulated polymeric foam with a metal slurry, and sintering, leaving a network of open cells interconnected by metal strands. The metal foam is matched to the environment to which it is exposed. For example, the fuel flow field 108 contains a metal with properties suitable for a humid, hydrogen atmosphere. These properties include good electrical conductivity, corrosion resistance, mechanical strength and sulfur tolerance. The air flow field 110 in the cathode compartment must be oxidation resistant, and have good electrical conductivity and mechanical strength. The metals are preferably ferritic stainless steels, which have a thermal expansion coefficient that is similar to YSZ.

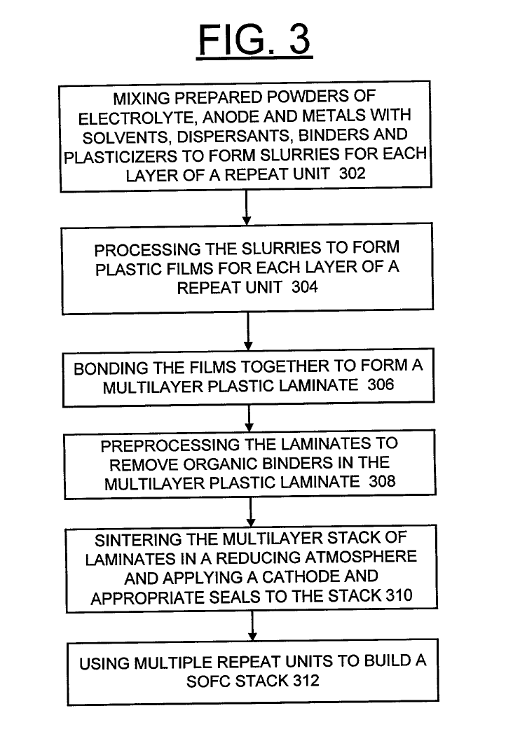

Referring to FIG. 3, there are shown exemplary steps for producing the solid oxide fuel cell repeat unit 100 in accordance with the preferred embodiment. Ceramic and metal powders are mixed with solvents and binders to form slurries as indicated in a block 302. The slurries are processed, such as tape-cast and dried, to form plastic films as indicated in a block 304. Then the films are bonded together forming a multilayer plastic laminate as indicated in a block 306. Laminates are thermally preprocessed to remove the organic binders as indicated in a block 308. Next the multilayer stack of laminates is then sintered in a reducing atmosphere and the cathode and appropriate seals are applied to the stack as indicated in a block 310. After applying the cathode and appropriate seals, the repeat unit 100 is used to build a SOFC stack as indicated in a block 312.

Fabrication Processing Example

Solid oxide fuel cell repeat units are formed by slurry casting processes followed by multilayer lamination, binder removal, and sintering in a reducing or otherwise controlled oxygen-free atmosphere. Traditional ceramic sintering takes place in air to achieve a dense oxide. In this invention, sintering is performed under a controlled reducing atmosphere to prevent the metal components from oxidizing, while maintaining the oxidized state of the ceramic oxide.

Various slurries are prepared containing oxide or metal powders, solvents, dispersants, binders, plasticizers, and pore formers as needed. The binder system can be chosen from a variety of commercially available materials including polyvinyl, acrylic resin, or cellulose types, the only criteria being that the binder system not interact with the ceramic or metal powders.

The electrolyte 102 is first cast on a detachable substrate using a doctor blade, spray-painting, or screen-printing to a thickness of 1 to 10 mils, typically 25-250 micrometers. After drying, one or more anode layers 104 are cast over the electrolyte film 102 to a thickness of 10 to 50 mils, typically 250-1250 micrometers. The electrolyte/anode bilayer 102, 104 is then removed from the substrate and is cut to the desired dimensions.

Foam flow fields 108, 110 are prepared by dipping reticulated polymer foam into the metal slurry and rolling out excess slurry to maintain open porosity. The pore density in the foam ranges from 30 to 80 pores per linear inch and the thickness ranges from 3 to 5 mm depending on the flow requirements of the fuel or air electrodes. After drying, the foam is cut to the desired dimensions. The air flow field 110 is cut to slightly smaller dimensions than the electrolyte/anode tape 102, 104 and fuel flow field 108 to allow for sealing during the fuel cell stacking step.

The metallic interconnect tape 106 is cast in a single layer or preferably as two or more layers containing metals that are suited to, respectively, the oxidizing and reducing environments. This is done by sequentially casting layers, or by laminating cured tapes together. After the laminate is cured, it is cut to dimensions slightly larger than the electrolyte/anode tape and the fuel foam layer, to provide a tab for attaching the repeat unit to the manifold plate. The interconnect 106 is sandwiched between the flow fields 108, 110 by gluing with a solvent or by pressing with applied heat. This sandwich 106,108, 110 is then laminated to the electrolyte/anode tape 102, 104.

The finished laminate stack is settered in a controlled atmosphere furnace for binder removal and sintering. A tube furnace is adequate for laboratory-scale production, whereas large-scale production would benefit from a continuous belt furnace. The binder removal step is carried out in air, nitrogen or hydrogen, depending on the removal requirements of the organic system. The furnace is heated at a slow rate and held at a temperature of 300-500° C. for several hours, sufficient to decompose the organic components of the system. After binder removal, air is purged from the chamber by vacuum or a flowing inert gas. A hydrogen/steam mixture is then introduced into the chamber and the furnace is heated to the sintering temperature. After sintering, the furnace is cooled and an inert gas or vacuum is applied to sweep out the hydrogen in the chamber.

After cooling, the sintered repeat unit 100 is masked for the application of the cathode 114. The cathode slurry is painted or printed over the exposed surface and allowed to dry. The cathode slurry 114 contains a perovskite powder that has been optimized for SOFC performance at 500-800° C. temperature range. The cathode slurry 114 also contains a binder to bond the powder to the electrolyte surface 102 during the stacking process and a chelated-metal precursor to aid in bonding the perovskite particles together. At this point, the cathode 114 can be bonded to the electrolyte 102 in a separate sintering step, heating up to 800° C., or preferably sintered during the initial heating of the stack.

The repeat unit 100 is then brazed or attached to the gas manifold plate 112 using a slurry that contains brazing powder that melts during the initial stack heating. Further sealing is provided by using the compressible mica-based high temperature gasket 116 as illustrated in FIG. 2.

### EXAMPLE 1

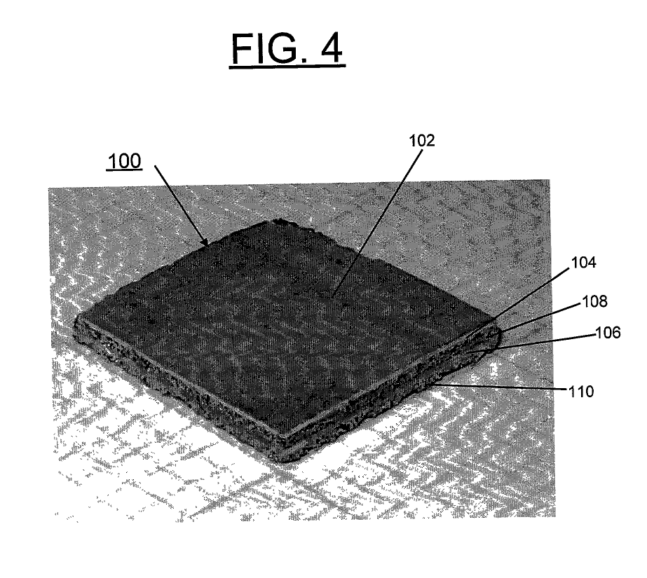

An exemplary repeat unit 100 fabricated by the process described above is shown in FIG. 4. The top layer consists of a 10-micrometer YSZ electrolyte 102 and a 300-micrometer porous nickel-YSZ anode 104. The reticulated porous layer below the electrolyte/anode is the fuel flow field 108, followed by the dense interconnect 106 and the air flow field 110.

### EXAMPLE 2

The mechanical performance of a commercially available anode-supported electrolyte cell (no cathode) in the reduced state has been compared with the invention (repeat unit 100, no cathode). Four samples of the anode-supported cell and three of metal-supported cell were mechanically stressed using the standard 4-point bending test, placing the electrolyte in compression.

The average strength of the commercially available anode-supported cells was 0.125 GPa. The cells failed catastrophically at this stress resulting in complete fracture of all the samples.

The repeat units 100 were strained just beyond the elastic yield point of the metal component, at which point, all ceramic layers had cracked and/or delaminated. Two stress-strain events could be observed before the yield point was reached in each of these samples. One event is due to the layers cracking and the second a delamination of the ceramic layers. At present, it is not possible to resolve which event occurs at the lowest stress. The strength data for these samples has been calculated from the lowest stress-strain event. The anode plus electrolyte thickness has been used in the strength calculation and not the thickness of the metal mesh and interconnect because the metal components had not fractured over the testing range. The thickness of the electrolyte/anode layers were calculated from SEM pictures.

The average strength of the ceramic layers in the metal-supported cells was 0.79 GPa. Clearly, the ceramic components of the invention can withstand higher stresses than the anode-supported cells, which indicates that the metal support plays some role in the mechanical properties of the ceramic components, inhibiting the formation of cracks and improving the strength and toughness of the cell.

While the present invention has been described with reference to the details of the embodiments of the invention shown in the drawing, these details are not intended to limit the scope of the invention as claimed in the appended claims.

What is claimed is:

1. A solid oxide fuel cell (SOFC) repeat unit comprising:
a multilayer laminate; said multilayer laminate including a metallic air flow field;
a metallic interconnect disposed on said metallic air flow field;
a metallic fuel flow field disposed on said metallic interconnect;
an anode disposed on said metallic fuel flow field, and
an oxide electrolyte disposed on said anode.

2. A solid oxide fuel cell (SOFC) repeat unit as recited in claim 1 wherein said anode and said oxide electrolyte are ceramic components and wherein said multilayer laminate has enhanced mechanical properties provided by supporting said ceramic components on said metallic layers including said metallic fuel flow field, said metallic interconnect, and said metallic air flow field.

3. A solid oxide fuel cell (SOFC) repeat unit as recited in claim 1 wherein said multilayer laminate is bonded together during sintering, whereby said metallic fuel flow field, said metallic interconnect, and said metallic air flow field provide enhanced electrical conduction properties.

4. A solid oxide fuel cell (SOFC) repeat unit as recited in claim 1 wherein said oxide electrolyte is a thin oxide electrolyte having a thickness in a range between 1 to 50 micrometers; said electrolyte includes one layer or multiple layers formed of an ion-conducting material selected from the group of yttria-stabilized zirconium oxide, doped cerium oxide and doped lanthanum gallium oxide.

5. A solid oxide fuel cell (SOFC) repeat unit as recited in claim 1 wherein said anode is a metal-ceramic anode including one or multiple porous layers formed of a mixture of metal or metal alloy and an ion-conducting oxide; said metal or metal alloy selected from the group of nickel, nickel alloys, and electrocatalytic metals; and said ion-conducting selected from the group of yttria stabilized zirconium oxide, doped cerium oxide, and doped lanthanum gallium oxide.

6. A solid oxide fuel cell (SOFC) repeat unit as recited in claim 1 wherein said metallic fuel flow field and said metallic air flow field include a porous metallic structure formed of metal or metal alloy; said metallic fuel flow field made up of metals or alloys compatible with the environment in the anode compartment of the fuel cell; and said metallic air flow field made up of metals or alloys compatible with the environment in the cathode compartment of the fuel cell.

7. A solid oxide fuel cell (SOFC) repeat unit as recited in claim 1 wherein said metallic interconnect is a compositionally graded metallic plate having respective outside surfaces compatible with an oxidizing air environment and a reducing fuel environment.

8. A solid oxide fuel cell (SOFC) repeat unit as recited in claim 1 includes a cathode applied to said oxide electrolyte and a manifold plate sealed to the SOFC repeat unit for building a SOFC stack of multiple repeat units.

9. A method of making a solid oxide fuel cell (SOFC) repeat unit including a metallic air flow field, a metallic interconnect, a metallic fuel flow field, an anode, and an oxide electrolyte, said method comprising the steps of:
mixing a powder of a predefined composition with solvents, dispersants, a plasticizer and an organic binder to form a slurry for each layer of the repeat unit;
processing the slurries to form films for each layer of the repeat unit;
bonding the films together to form a multilayer laminate; and
sintering said multiplayer laminate in a reducing atmosphere.

10. A method of making a solid oxide fuel cell (SOFC) repeat unit as recited in claim 9 wherein the steps of mixing said powder of a predefined composition with said solvents, said dispersants, said plasticizer and said organic binder to form said slurry for each layer of the repeat unit includes the steps of mixing said powder of an ion-conducting material selected from the group of yttria-stabilized zirconium oxide, doped cerium oxide and doped lanthanum gallium oxide with said solvents, said dispersants, said plasticizer and said organic binder to form said slurry for the oxide electrolyte.

11. A method of making a solid oxide fuel cell (SOFC) repeat unit as recited in claim 10 includes the steps of mixing said powder of a mixture of metal or metal alloy and an ion-conducting oxide to form said slurry for the anode; said metal or metal alloy selected from the group of nickel, nickel alloys, and electrocatalytic metals; and said ion-conducting selected from the group of yttria stabilized zirconium oxide, doped cerium oxide, and doped lanthanum gallium oxide.

12. A method of making a solid oxide fuel cell (SOFC) repeat unit as recited in claim 10 includes the steps of mixing said powder of a predefined metal or metal alloy composition to form one or more slurries for each of the metallic air flow field, the metallic interconnect, and the metallic fuel flow field.

13. A method of making a solid oxide fuel cell (SOFC) repeat unit as recited in claim 9 wherein the steps of processing the slurries to form films for each layer of the repeat unit includes the steps of casting an electrolyte film on a temporary substrate to form a thin electrolyte tape; and overlaying said electrolyte film with one or more films forming the anode by one of successively casting one or more slurries for the anode over said electrolyte film or laminating cured tapes for the electrolyte and the anode together.

14. A method of making a solid oxide fuel cell (SOFC) repeat unit as recited in claim 9 wherein the steps of processing the slurries to form films for each layer of the repeat unit includes the steps of coating a reticulated polymeric foam with a metal slurry to form the metallic fuel flow field.

15. A method of making a solid oxide fuel cell (SOFC) repeat unit as recited in claim 9 wherein the steps of processing the slurries to form films for each layer of the repeat unit includes the steps of tape-casting and overlaying layers of multiple metal interconnect slurries on a temporary substrate; said multiple metal interconnect slurries having a selected composition for each overlay to provide a graded composition for the metallic interconnect, said compositionally graded metallic interconnect having an outside surface being compatible in oxidizing environment and an opposite outside surface being compatible in reducing environment.

16. A method of making a solid oxide fuel cell (SOFC) repeat unit as recited in claim 9 wherein the steps of processing the slurries to form films for each layer of the repeat unit includes the steps of coating a reticulated polymeric foam with a metal slurry to form the metallic air flow field.

17. A method of making a solid oxide fuel cell (SOFC) repeat unit as recited in claim 9 wherein the steps of processing the slurries to form films for each layer of the repeat unit includes the steps of cutting said tapes into the desired shapes.

18. A method of making a solid oxide fuel cell (SOFC) repeat unit as recited in claim 9 wherein the steps of bonding the films together to form said multilayer laminate includes the steps of heating said multilayer laminate in one of an air or neutral atmosphere at a sufficient temperature to remove the organic constituents.

19. A method of making a solid oxide fuel cell (SOFC) repeat unit as recited in claim 9 wherein the steps of sintering said multiplayer laminate in said reducing atmosphere includes the steps of sintering said multilayer laminate in a hydrogen atmosphere.
